(19) United States
(12) Patent Application Publication
(10) Pub. No.: US 2025/0296640 A1
(43) Pub. Date: Sep. 25, 2025

(54) MODULAR VEHICLE RACK SYSTEM

(71) Applicant: JOSEPH LUKE BALAY, Sugarloaf, PA (US)

(72) Inventor: JOSEPH LUKE BALAY, Sugarloaf, PA (US)

(21) Appl. No.: 19/080,797

(22) Filed: Mar. 15, 2025

Related U.S. Application Data
(60) Provisional application No. 63/567,451, filed on Mar. 20, 2024.

(51) Int. Cl. B62D 33/02

(52) U.S. Cl. CPC B62D 33/0207

(57) ABSTRACT

A modular rack system designed to be configurable for hauling various sizes and shapes of gear. The geometry of the rails in combination with corner supports allow components to be added or removed easily. Structural connection to the vehicle bed with or without a tonneau cover provides for offroad or heavy duty use. The rack is designed to fit within the aerodynamic profile of the vehicle to minimize its footprint when not in use. The lightweight construction, bracketry and vehicle connections allow the rack system to be removed from the vehicle without disassembly. When combined with a structural load carrying tonneau cover, gear can be supported by the cover aiding the load carrying capacity of the rack system. Height adjustment of the rack system provides clearance with the vehicle when carrying longer items.

### CROSS REFERENCE TO RELATED APPLICATIONS

Provisional Patent Application: 63/567,451

### PRIOR ART

U.S. Pat. No. 11,851,111B2 Modular truck bed rack system and portions thereof.
U.S. Pat. No. 10,421,385B2 Truck ladder rack
USD877041S1 Modular truck rack
USD624005S1 Truck rack

### BACKGROUND OF THE INVENTION

Rack systems are added to vehicles allowing the transportation of additional gear. Typically, the racks are not designed to be modified for mounting additional components or gear. Therefore, it is desirable to have improvements made for racks to allow their configurations to change based on the size and shape of the additional gear being transported. Most existing rack systems are fixed and do not allow adjustment in height. The addition of a rack system to a vehicle also negatively affects aerodynamics due to protruding above the vehicle roofline as well as the sides.

### SUMMARY OF THE INVENTION

This invention relates generally to vehicle racks, in particular to modular vehicle racks that are customizable based on the gear and loads they are used to transport. Components can be added or removed to adjust to the type, size and shape of the gear or load being transported. This design is easily adjusted to any vehicle bed size or rack height required with optional mounting configurations for bed rail or tonneau cover attachment to the vehicle.

The system is corrosion resistant, lightweight and has the strength to haul a significant amount of gear due to the construction and materials chosen. The rack being lightweight provides the added benefit of being able to remove or add it to the vehicle as needed. The combination of bolted and welded components allows for basic assembly steps and quick installation on the vehicle. The slotted support members allow additional gear and cargo to be fastened where needed without requiring tie down brackets or cleats.

The modular vehicle rack system solves several problems encountered with existing racks in the market. Most rack systems are not designed with the ability to adapt to the configuration required. They do not have the adjustability to carry various sizes and shapes of gear or equipment on top of or within them. This modularity provides additional equipment transportation space and flexibility to fit different shapes and types of gear.

Combining the rack with a structural tonneau cover adds an additional level of configuration and use by allowing gear to be transported on top of the cover but attached to the rack system to secure it in place for transport.

In this configuration, the main support corners of the rack system are structurally connected to the tonneau cover. They are angled on the exterior for aerodynamics and vertical on the interior for better load carrying capacity. Additional mounting bracket conventions would allow the rack system to be fastened to the bed rail of the vehicle or to other variations of tonneau covers.

There is adjustment to the height of the rack for loads that are longer than the vehicle bed length and extend above the cab of the vehicle. In its lowest setting, the rack system is flush with the top of the vehicle cab for better aerodynamics.

Aluminum strut is used for the horizontal members between the main support corners. The channel design lends itself to adding additional components or brackets easily to carry equipment such as kayaks and bikes. Mounting typical offroad tools such as gas cans, traction strips, axes, shovels, jacks, and spare tires can be attached as well.

Along with the ability to add additional members, some of the existing channels can be removed as needed. The shape of the extrusions in combination with the slots allow users to fasten additional gear/equipment as required. Roof top tents can be attached directly to the top horizontal members providing full perimeter support.

### BRIEF DESCRIPTION OF THE FIGURES

FIG. 1—Isometric view of the modular rack system

FIG. 2—Isometric view of the modular rack system, shown without the bottom rails, attached to a structural tonneau cover on a vehicle bed

FIG. 3—Isometric view of a corner support

FIG. 4—Isometric view of the modular rack system, as shown adjusted to an increased vertical height position

FIG. 5—Isometric view of the modular rack system, as shown with the bottom set of rails removed

FIG. 6—Isometric view of the modular rack system, as shown with the top perimeter rails, the adjustable rails are removed

FIG. 7—Isometric view of the modular rack system, as shown with the rear rail removed and (1) adjustable rail attached

FIG. 8—Isometric view of the modular rack system, as shown with the top and bottom rear rail removed and (1) adjustable rail attached to the top and bottom

FIG. 9—Plan view of a corner support shown in the standard vertical rack position

FIG. 10—Plan view of a corner support shown in the raised vertical rack position

FIG. 11—Isometric view of a front/rear rail support with mounting bracket and fasteners

FIG. 12—Isometric view of an adjustable rail with ends

FIG. 13—Isometric view of a driver/passenger side rail support with mounting bracket and fasteners

### DETAILED DESCRIPTION OF THE INVENTION

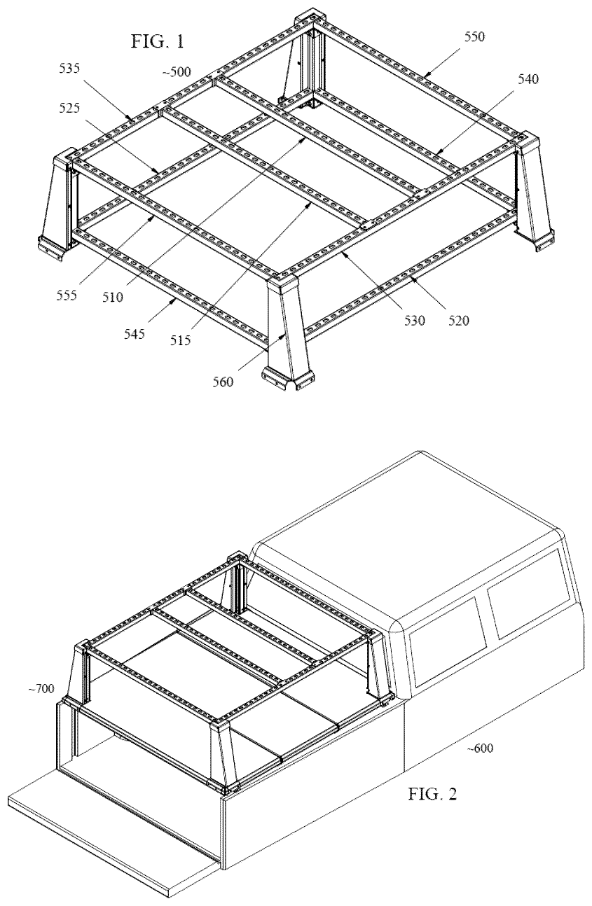

The modular vehicle rack system 500, FIG. 1, of the disclosed embodiments includes front top/bottom supports 550/540, rear top/bottom supports 555/545, (4) main support corners 560 and driver side top/bottom side rack supports 535/525, and passenger side top/bottom side rack supports 530/520 with adjustable rack supports 510/515.

As displayed, the rack system is built using extruded aluminum and aluminum sheet metal components, brake formed and welded. Variations can be made with other materials such as steel or fiberglass or steel but do not provide the same benefits of being lightweight and corrosion resistant.

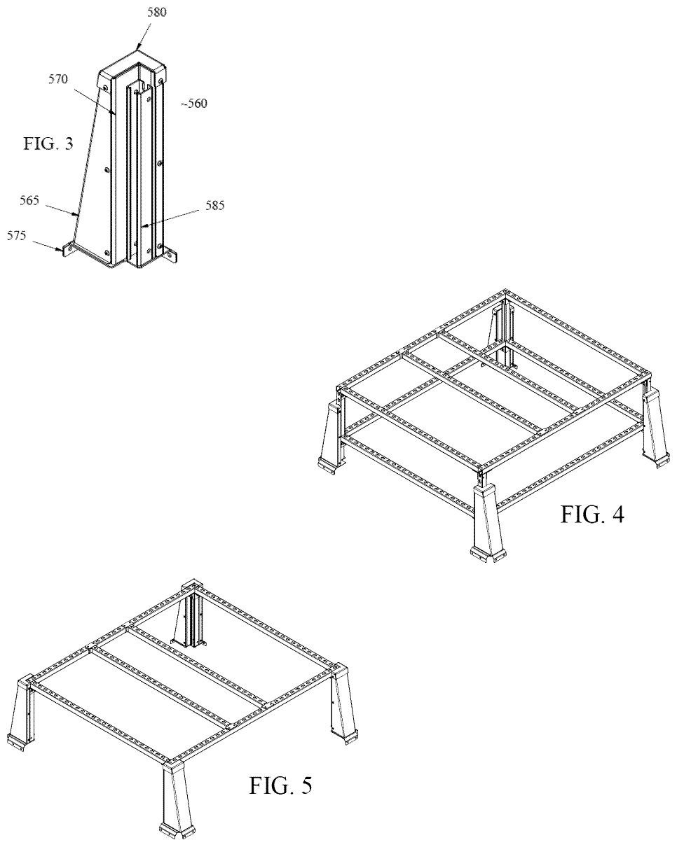

The (4) main support corners 560 are used to provide vertical structure to the rack system. They are attached to a vehicle bed 600 with rack attachment brackets 575, FIG. 3. Structural channels are used to allow the construction to remain strong and lightweight. While other channel geometry and shapes or extrusions can be used to construct the rack system, the enclosed embodiment was chosen due to providing the most benefits.

FIG. 3 details the main support corners 560 consisting of the rack attachment brackets 575, the outside corner support 565, the inner support corner 570, the trim cap 580 and the vertical rack supports 585. The outside corner support is the base assembly component of the main support corner 560 and is attached to the vehicle bed 600 or tonneau cover 700 using the rack attachment brackets 575, FIGS. 9 & 10. When used with a structural tonneau cover, the rack attachment brackets 575 are used to fasten the rack system 500 on both sides of the (4) corners. This provides a superior connection and allows for various setups shown in FIGS. 4-8. Direct attachment to the vehicle bed is possible with different rack attachment brackets but would not carry all the benefits of the invention as described herein.

In its current configuration, removing the bolts from the rack attachment brackets 575 allows the entire rack system to be removed from the vehicle bed 600 as one piece. The rack system weighs approximately 60 lbs and allows the user to remove it from the vehicle as desired with minimal effort. While some of the connections of brackets and strut channels are bolted, these can be welded but would limit the adaptability for the customer to modify the configuration to fit their needs.

The rack attachment brackets 575 can vary in design to allow the rack system to be attached to a structural tonneau cover 700, as shown in FIG. 2, a tonneau cover rail, or a vehicle bed 600. This flexibility allows it to be used on various vehicles options, with the most beneficial combination identified with a structural tonneau cover 700. In the enclosed embodiment, the rack attachment brackets maintain the rigidity of the system by bolting on both sides of the corner of the tonneau cover 700, also shown in FIG. 2. This type of connection allows for the rear configuration of the rack system as shown in FIGS. 7-8.

The adjustable rack supports 510/515 are designed to be placed as needed depending on the rack configuration. This ability is shown in FIGS. 4-8 where they are installed in a variety of locations. They can also be used on the bottom set of supports as displayed in FIG. 8 to provide additional structure or be located to hold gear in place. By welding the end attachment brackets 511 to the adjustable rack support, they can bolt to the top side rack supports 530/535 in any location along their length, shown in FIGS. 7-8.

In the rear loading configuration, FIGS. 7-8, the adjustable rack supports 510/515 can easily be removed allowing gear to be loaded onto a structural tonneau cover 700 from the rear of the vehicle, then replaced to secure the gear in place for transport.

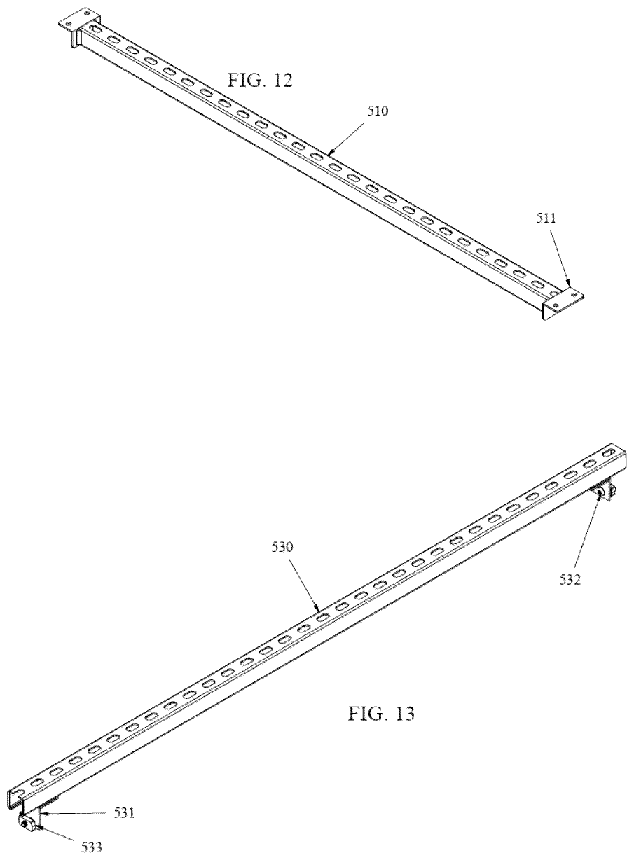

The adjustable rack supports 510/515 can be relocated depending on the shape of the gear or items being hauled. They also assist in freeing up the center of the rack to help load cargo, then are easily replaced to secure it for transport. Slotted strut was used to allow additional components or bracket mounting, as shown in FIG. 12. Solid strut would provide a higher load capacity but limits the modularity of the rack system requiring holes to be drilled to add components. Variations of tube and/or other extrusion shapes could be used in place of the strut members but would not provide the benefits described in the enclosed embodiments.

Within each of the (4) main support corners 560 are the vertical rack supports 585. This bolted connection is how the rack can be raised above the roof of the vehicle. The current configuration can be raised 4″-6″, shown in FIG. 2, by using the pre-punched slots 586 in the vertical rack supports 585. The bolts 590 are removed to allow the rack system 500 to be raised and lowered and then reinstalled to connect them to the interior upright 570.

Additional members or panels can be attached to the top/bottom side rack supports 530/520 and 535/525 to allow additional gear and equipment to be carried on the exterior of the rack system. The supports are set to the interior of the main support corner 560 to help reduce negative impacts to the aerodynamics of the vehicle.

Removing the bottom side rack supports 520/525 as shown in FIGS. 5-7, demonstrates some of the configurations available to be used in conjunction with a structural tonneau cover 700. These configurations allow the rack system to be used, while still providing access to the structural tonneau cover 700 for attaching and hauling additional gear below it.

FIG. 11 shows the construction of the front top/bottom supports 550/540 and the rear top/bottom supports 555/545. The enclosed invention uses connection brackets 541 on either end, welded to the longitudinal member 540. The top/bottom supports are attached using threaded knobs 542 to the vertical rack supports 585 on both ends. This bolted connection allows easy removal to adapt the rack system to other load configurations shown in FIG. 4-7. Bolts can also be used to replace the threaded knobs 542, but limit the adaptability of the rack system without tools.

The top side rack supports 530/535 are constructed with a welded connection bracket 531 on both ends. The location of the connection brackets 531 is set to receive the vertical rack supports 585 of both main support corners 560 they are assembled to. This location allows the top side rack supports 530/535 additional support by sitting on top of the vertical rack supports 585 on both ends. FIG. 13 displays the connection brackets 531 and the bolt 532 and nut 533 used to fasten to the vertical rack supports 585.

The bottom side rack supports 520/525 are constructed in the same manner as the top side rack supports 530/535, but the connection brackets 531 are placed flush with the ends to allow them to be located within the vertical rack supports 585 at each main support corner 560 on both driver and passenger sides of the rack system 500.

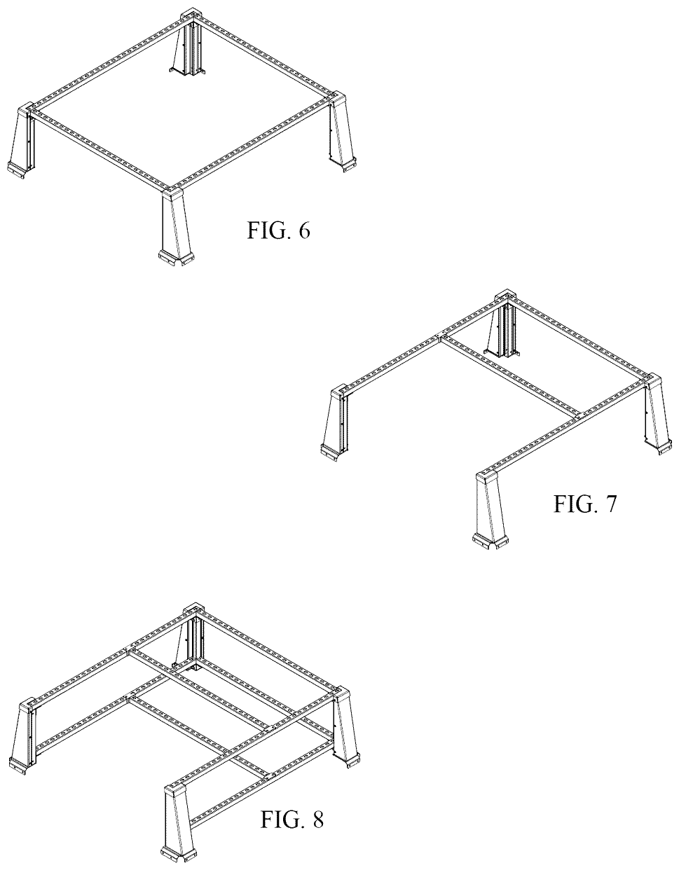

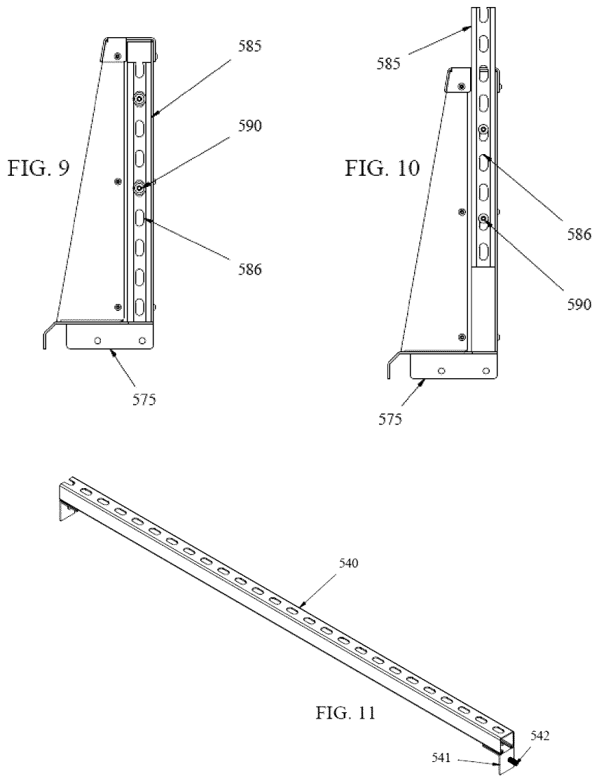

Aluminum was chosen for its light weight and corrosion resistance without additional treatments. The combination of shapes and materials used in this variation were chosen to provide the lightest and strongest combination of the options available. One option, such as angular corner support brackets could be used to provide additional structure and load carrying capacity to the modular rack system. The embodiments describing the invention are specific, but other variations or modifications can be made within the scope of this design. The modular rack system is designed with a combination of bolted and welded assembly allowing it to be adjusted to fit any vehicle size by changing the length of the rails used. It will ship to the customer disassembled so they can determine whether to use the full assembly shown in FIG. 1, or in a minimal configuration shown in FIG. 6.

The enclosed embodiments include a combination of welding, bolting and various fastener types and designs for its construction. While this assembly was determined to be the most beneficial, other fastening methods could be applied and the methods displayed herein are not meant to limit the invention.

1. A modular vehicle rack system comprising, (4) corner supports with bottom attachment brackets, and a top and bottom set of rails connected to vertical members, and using adjustable support members connected to the top and bottom rails across the width of the vehicle bed.

2. The corner uprights of claim 1, wherein said uprights are constructed of aluminum, and are connected to bottom corner attachment brackets, and are bolted together with inner corner uprights to form a structural corner, and contain a vertical member to connect to the perimeter rails of the rack system.

3. The bottom corner attachment brackets of claim 2, wherein attachment flanges wrap the corner of a tonneau cover, and have mounting holes for attachment to a structural tonneau cover system and the vehicle.

4. The top and bottom set of rails of claim 1 comprising, horizontal rails running from front to rear of the vehicle bed, and horizontal rails running from driver to passenger side of the vehicle bed, and connect to the vertical member at each of the corner supports.

5. The vertical members of claim 4, wherein are made using aluminum extrusions, and are bolted to the inner corner uprights, and have a series of slots to allow adjusting the rack system height.

6. The bottom set of rails of claim 4, wherein said rails can be removed from the rack system, and the removal allows access to the rack system interior from the sides or rear, and can be reattached as required to provide more connection points for attaching additional gear.

7. The adjustable support members of claim 1, wherein are added to the system when additional structure is required and are easily removed to allow gear to be loaded into the rear of the rack system, and are easily replaced to secure gear in place while transporting.

8. The rear top and bottom rails of claim 4, wherein the connection to the vertical members allows easy removal from the rack system, and therefore assists in the ability to load gear freely from the rear of the vehicle, and contains the gear within the remainder of the rack system attached to the vehicle.

9. The top/bottom set of rails from claim 4 further comprising, aluminum extrusions with a geometry that can support a significant load, and are constructed with slots along the length, and the slots provide additional load securing positions, and allow attaching additional members or removing members to adjust to the load being hauled.

10. The modular vehicle rack system of claim 1, wherein is constructed of lightweight materials, and is designed to fit within the aerodynamic profile of the vehicle, and can be removed from the vehicle without having to be disassembled by disconnecting it at the attachment points to the vehicle or tonneau cover.
